(19) United States
(12) Patent Application Publication
(10) Pub. No.: US 2012/0286094 A1
(43) Pub. Date: Nov. 15, 2012

(54) Helicopter Cargo Basket Mounting Assembly and Method of Using Same

(75) Inventors: Michael Petsche, St. Lasare (CA); Alan Stocker, Rockland (CA)

(73) Assignee: DART AEROSPACE LTD., Hawkesbury, ON (CA)

(21) Appl. No.: 13/576,648

(22) PCT Filed: Feb. 1, 2011
(86) PCT No.: PCT/CA2011/050059

§ 371 Date: Aug. 1, 2012

(30) Foreign Application Priority Data
Feb. 1, 2010 (CA) 2691481

(51) Int. Cl. B64D 9/00; B64C 27/04

(52) U.S. Cl. 244/131; 403/52

(57) ABSTRACT

A mounting assembly for mounting an external cargo basket onto a helicopter and a method of using the mounting assembly. The mounting assembly comprises a plurality of connectors—corresponding male and female connectors being positioned on the helicopter and on the basket, one of said corresponding connectors being an articulating connector. The cargo basket is connected to the helicopter by first connecting the articulating connector then pivoting and rotating the cargo basket using the articulating connector so as to align and connect the remaining connections.

### FIELD OF THE INVENTION

The present invention relates to a helicopter external cargo basket mounting assembly and method of mounting a helicopter cargo basket to a helicopter using the mounting assembly.

### BACKGROUND OF THE INVENTION

Helicopters are extremely versatile aircraft. Because of their ability to hover, and take off and land vertically, they are employed for a very wide variety of missions. As such, they are occasionally required to carry external cargo. The cargo may be too large to be accommodated in the aircraft cabin or the cargo itself could pose a hazard to the occupants of the aircraft.

A number of options are available for carrying cargo externally. For example, a cable extending from the helicopter can be used to lift cargo, either in a net, or in a basket, pod or the like. Alternatively, external cargo baskets have been developed in order to facilitate the transportation of external cargo. These are typically mounted to the helicopter landing gear and provide a sealable compartment within which cargo can be placed for secure transportation. An example of such an external cargo pod is taught in U.S. Pat. No. 3,778,011.

Given the variety of missions a helicopter may undertake, there are many missions for which an external cargo basket is not required. Because the basket negatively impacts fuel consumption, aerodynamics, manoeuvrability and overall safety, it is preferable that it be removed when not required. However, while there are several types of cargo baskets which currently exist, none of them have a simple mounting system allowing the removal and installation of the basket, single-handedly, without requiring any tools.

It is therefore an object of an embodiment of this invention to provide an external carrier basket with a simple mounting system that allows for mounting of the basket to a helicopter without the use of tools.

Other objects of the invention will be apparent from the description that follows.

### SUMMARY OF THE INVENTION

The invention consists of a mounting assembly for an external cargo basket that allows for singlehanded installation and removal without the use of tools and a method for mounting of a cargo basket on a helicopter using same.

According to the preferred embodiment of the invention there is provided a mounting assembly for mounting an external cargo basket on a helicopter comprising a plurality of connectors, at least one of said plurality of connectors being an articulating connector.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

These and other features of the invention will become more apparent from the following description in which reference is made to the appended drawings and wherein:

FIG. 1 is a front view of a helicopter equipped with an external carrier basket connected using the preferred embodiment of a mounting system according to the invention;

FIG. 2 is a rear view of the helicopter and basket of FIG. 1, with the rear basket connections shown disconnected;

FIG. 3 is perspective view of a front portion of the carrier basket of FIG. 1 shown disconnected from and adjacent to the helicopter skid of the helicopter shown in FIG. 1;

FIG. 4 is a perspective view of the basket and helicopter skid shown in FIG. 3 with the basket connected to the helicopter skid using the preferred embodiment of a mounting system according to the present invention;

FIG. 5 is a perspective view of a rear portion of the carrier basket of FIG. 1 shown disconnected from and adjacent to the helicopter skid of the helicopter shown in FIG. 1;

FIG. 6 is a perspective view of the basket and helicopter skid shown in FIG. 5 with the basket connected to the helicopter skid using the preferred embodiment of a mounting system according to the present invention;

FIG. 7 is a front perspective view of a swivel connector according to the present invention;

FIG. 8 is an exploded perspective view of the swivel connector of FIG. 7;

FIG. 9 is a perspective view of the swivel connector of FIG. 7, with the right bracket plate removed;

FIG. 10 is a perspective view of the swivel connector of FIG. 7, with the left bracket plate removed.

FIG. 11 is an exploded perspective view of the swivel connector of FIG. 7 taken from the rear.

### DESCRIPTION OF THE PREFERRED EMBODIMENTS

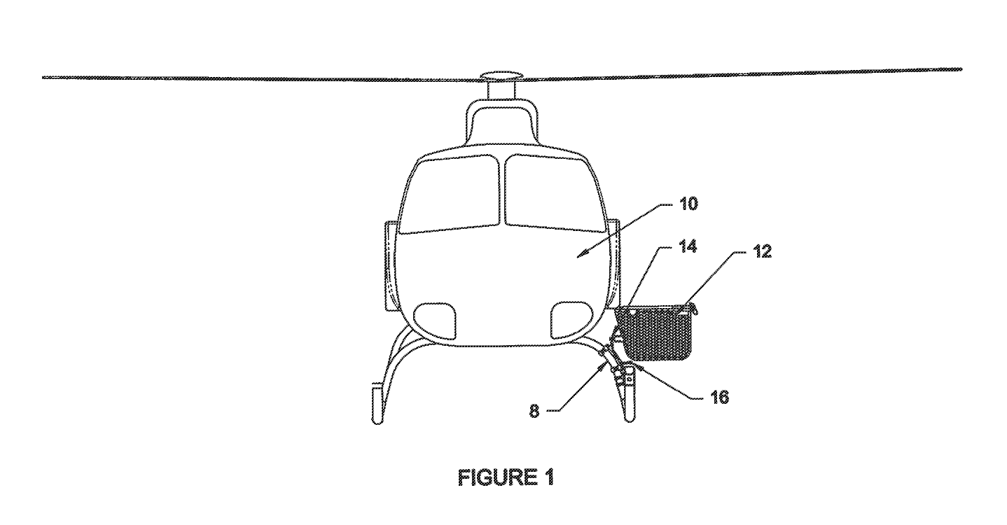

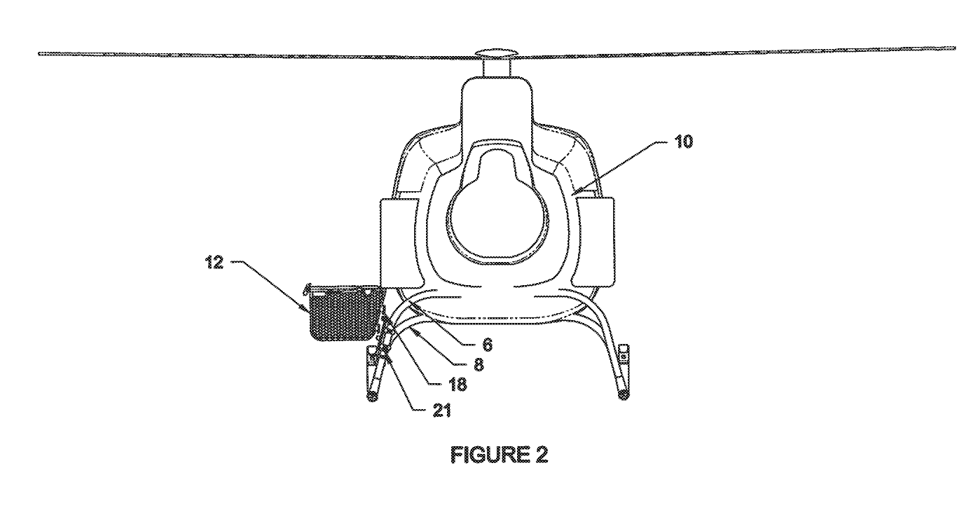

A helicopter 10 is shown in FIGS. 1 and 2 in the process of being equipped with an external cargo basket 12. The basket is shown in position to be mounted on the forward 8 and aft 6 helicopter landing gear crosstubes using a mounting assembly according to the invention. While the mounting assembly of the invention is shown in use with a particular helicopter and basket design, it is contemplated that the invention can be adapted to any number of basket designs and helicopter designs, provided the helicopter is equipped with a fixed position landing gear or other fixed position component to which the mounting system and cargo basket can be connected.

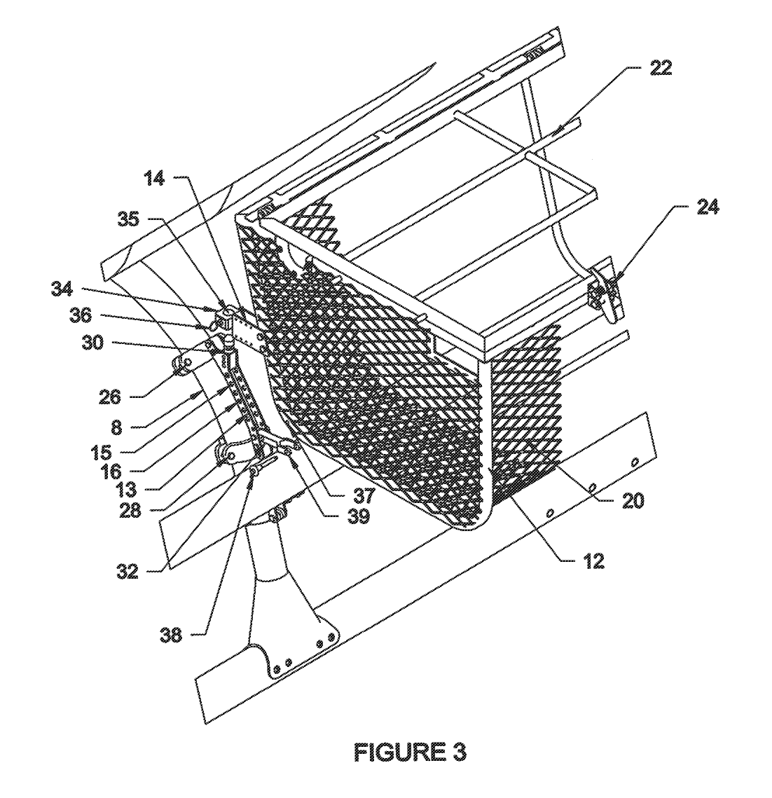

It is contemplated that the basket itself could come in a variety of shapes and sizes and could be manufactured using different materials. The basket 12 shown in the drawings is made of a frame to which a stainless steel mesh 20 (note that only a portion of the mesh is shown in the drawings for illustrative purposes) is connected to form an enclosure within which objects can be stored during transport. A lid 22 can be opened or closed using the handle assembly 24 shown in FIG. 3.

The basket is mounted to the helicopter crosstubes 8, 6 by way of the mounting assembly, which comprises forward 16 and aft 18 mounting assemblies. Both the forward mounting assembly 16 and the aft mounting assembly 18 will be discussed in detail. It is contemplated that the orientation of the individual mounting assemblies could be reversed, with mounting assembly 16 being positioned on and connected to the aft crosstube 6 and mounting assembly 18 being positioned on and connected to forward crosstube 8.

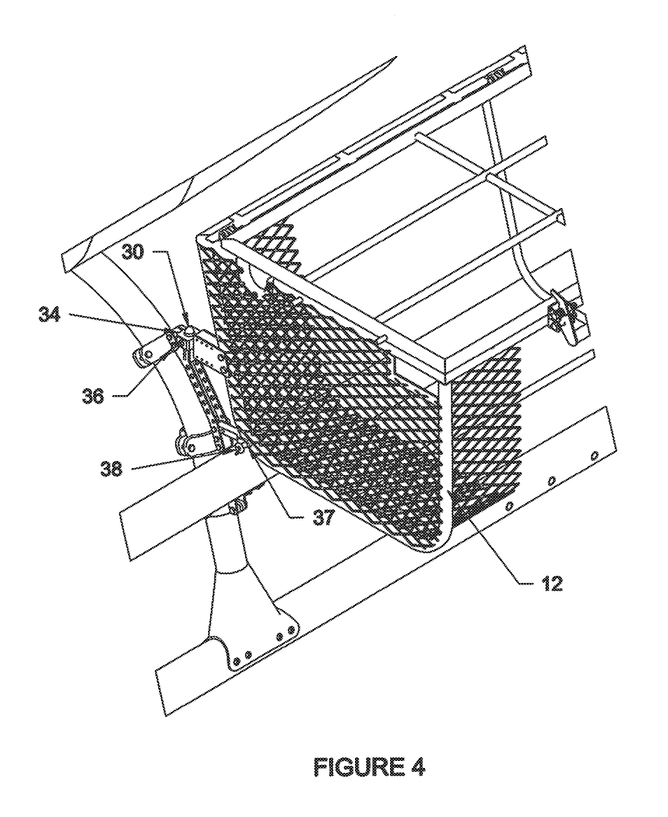

Forward mounting assembly 16 will now be described with reference to FIGS. 3 and 4. The mounting assembly 16 is comprised of a mounting element 13 fixedly connected to the helicopter and having upper mount 30 and lower mount 32 and a pair of corresponding connectors 14 and 37 on the basket. Preferably, mounting element 13 is a clamp link fastened to the forward crosstube 8 by machined aluminum clamps 26 and 28. Mounting element 13 is preferably comprised of a pair of spaced elongated metal plates 15 connecting at the top to clamp 26 and at the bottom to clamp 28 by way of fixed connection such as bolts, screws, welding, rivets or the like. Mounting element 13 is equipped with an upper mount in the form of receiver pin 30 and a lower mount in the form of y-shaped yoke 32 at the bottom, both of which are connected to, and sandwiched between, the metal plates. The clamp link 13 fixes the relative position of the upper and lower clamps 26, 28 and in turn, the upper and lower mounts 30 and 32 simplifying their alignment with the corresponding connectors 14 and 37 on the basket as compared to those mounting systems having individually connected upper and lower mounts. In order to minimize the weight of the mounting element 13, the metal plates 15 preferably include a plurality of spaced openings to reduce the overall material (and weight) with limited impact to the overall strength.

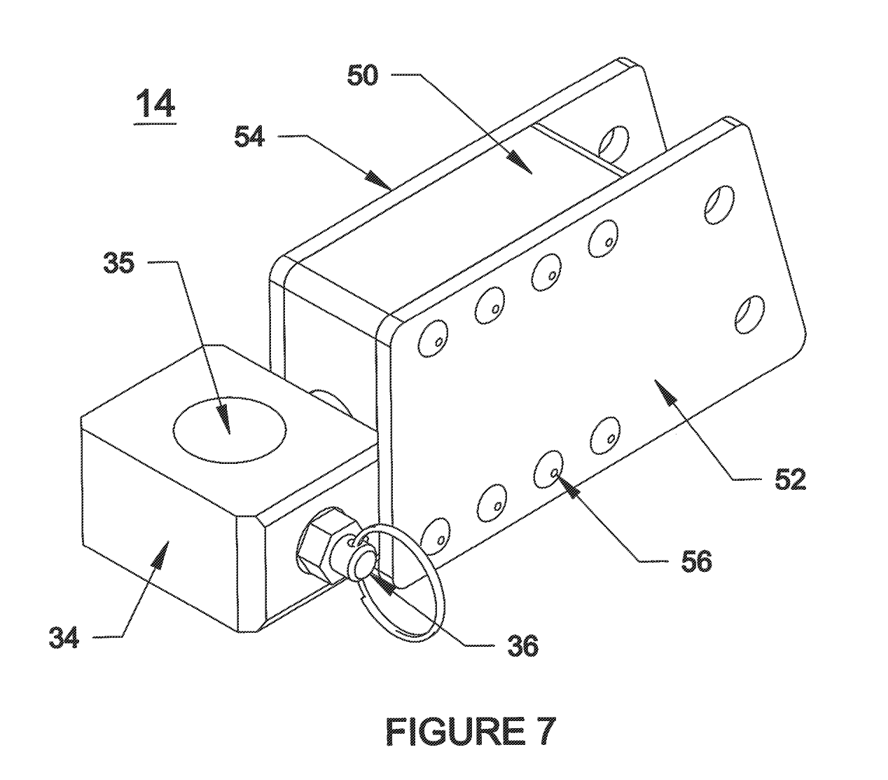

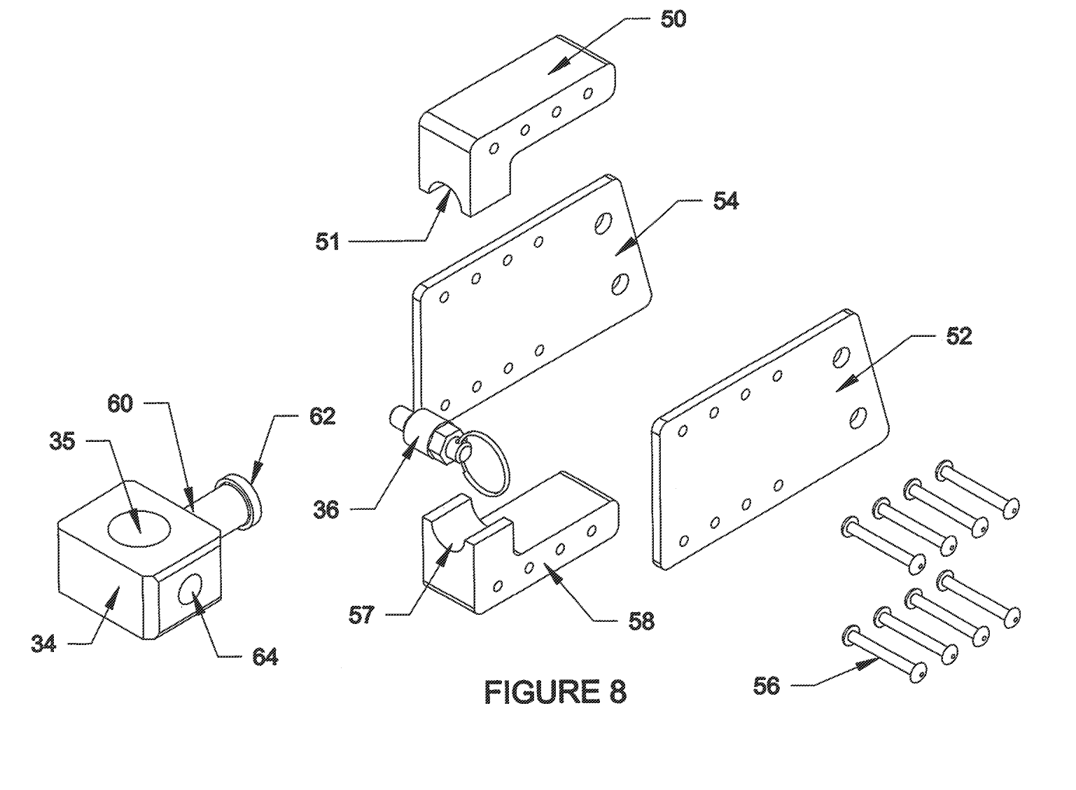

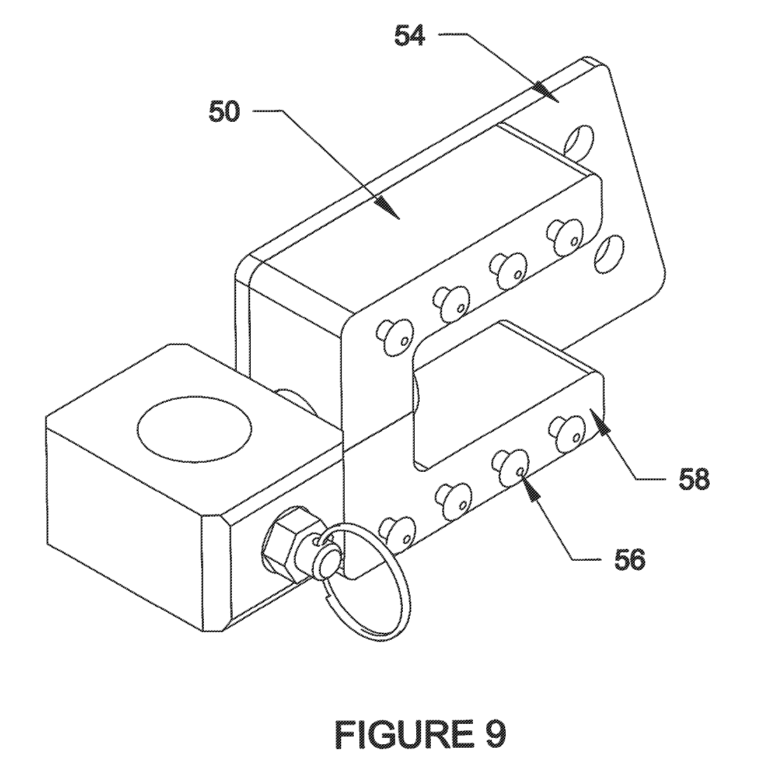

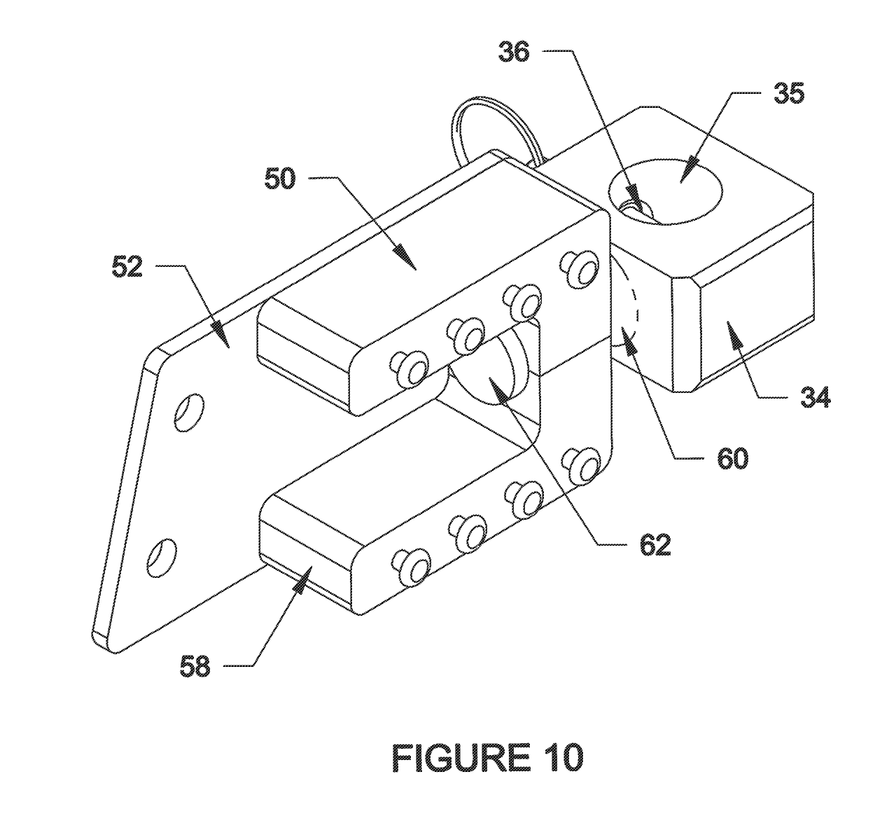

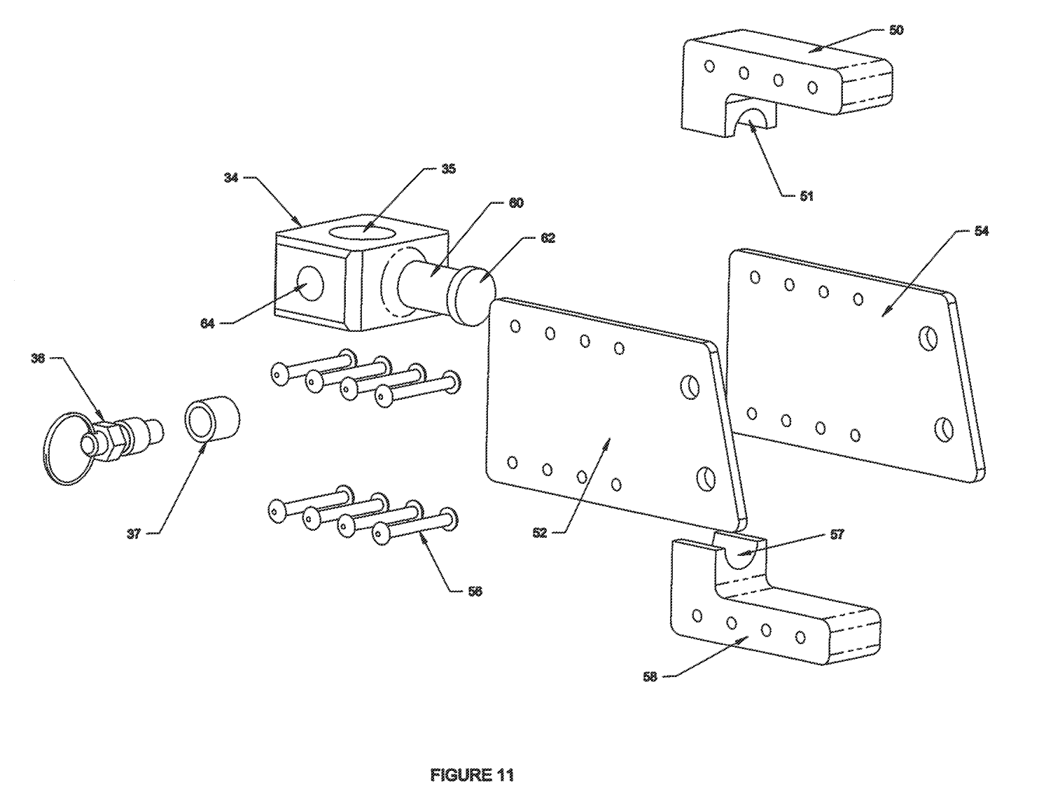

The forward end of the basket has an articulating upper connector 14 mounted thereto for connecting to upper mount 30 as will be described in greater detail below with reference to FIGS. 7-11. The y-shaped portion of yoke 32 is preferably sized to accommodate a portion of the frame of basket 12. A mounting hole 37 in basket 12 can be aligned with the corresponding holes 39 in the y-shaped yoke and safety pin (a pip-pin) or rod 38 inserted therein in order to complete the connection.

Articulating connector 14 is preferably a gimbal assembly comprising a pair of sandwich or sheer plates 52, 54 between which are sandwiched gimbal retainer blocks 50 and 58, which in turn hold in place gimbal pin 34. The gimbal assembly is preferably held together by way of rivets 56 or the like. Gimbal pin 34 has a gimbal pin shank 60 extending therefrom and terminating in a shoulder 62. The retainer blocks 50 and 58 are mirror images of one another, with each one having a semi-circular bore 51 and 57, respectively. When connected, the semi-circular bores 51 and 57 define a bore hole within which gimbal pin shank 60 is seated. The diameter of the bore hole defined by bores 51 and 57 is greater than the diameter of gimbal pin shank 60, but less than the diameter of shoulder 62. Gimbal pin 34 is therefore able to revolve independently of the gimbal retainer block, move in and out to the extent allowed by the gimbal pin body and the shoulder 62. The gimbal pin has a cylindrical opening 35 adapted to be connected to upper mounting pin 30. The gimbal pin 34 is therefore able to revolve in relation to the upper mounting pin 30. A spring-loaded lock pin 36 fitted into threaded hole 64 automatically engages with a machined groove in upper mounting or receiver pin 30. In order to disconnect the gimbal pin 34 from receiver pin 30, the lock pin 36 must be disengaged by pulling it outwards.

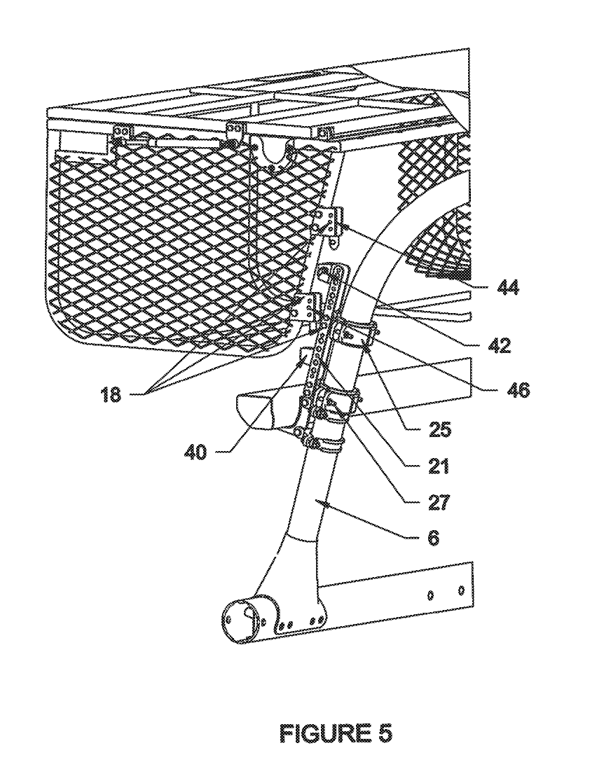

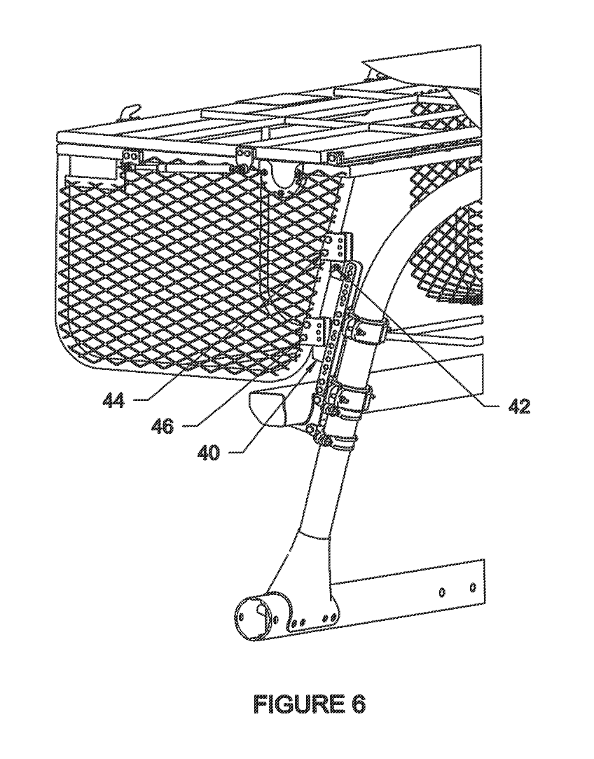

Turning to FIGS. 5 and 6, the aft mounting assembly 18 preferably comprises a mounting element or frame 21 and a pair of connectors 44, 46 connected to the basket 12. Mounting frame 21 is connected to aft crosstube 6 by way of upper clamp 25 and lower clamp 27 and is similar in construction to mounting element 13. The connectors at the rear of the basket 12, upper connector 44 and lower connector 46, are connected via bolts or the like to a portion of the frame of basket 12. Mounting frame 21 is also preferably fitted with two connectors, upper mounting frame connector 42 and lower mounting frame connector 40. As shown in FIGS. 5 and 6, upper basket connector 44 and lower basket 46 are male connectors in the form of mounting pins or pintles and upper mounting frame connector 42 and lower mounting frame connector 40 are corresponding female connectors in the form of pin receivers or gudgeons. The female connectors may be equipped with locking means, such as spring-loaded lock pins (as visible for upper receiving connector 42), for locking in place any male connector to be inserted into the female connector. Upper pin receiving connector 42 is adapted to receive upper pin connector 44 and lower pin receiving connector 40 is adapted to receive lower pin connector 46. It is also contemplated that the male and female connectors could be reversed or alternated (for example, upper mounting frame connector 42 could be a male connector such as a mounting pin with the corresponding upper basket connector 44 being a female connector in the form of a pin receiver) and that other male and female type connectors could be used as known in the art.

Use of the Mounting System

The forward mounting element and aft mounting frame are connected to the forward and aft crosstubes of a helicopter and positioned so that when a basket is mounted to them it is in the desired orientation (typically horizontal). An individual user preparing to mount a basket first aligns the basket with the helicopter on the ground so that the various connectors may be more easily connected. Lifting the forward end of the basket, the gimbal opening 35 is aligned with the upper receiver pin 30 and lowered onto it so as to engage the spring-loaded lock pin 36. Although the forward end of the basket is now fastened to the aircraft, the articulating connector provides a pivot point about which the basket is still free to swivel vertically, and inboard/outboard.

The operator now moves the aft end of the basket. Lifting the aft end of the basket the user is able to align the male and female connectors and, once aligned, connect them. Once the male and female connectors (pintle and gudgeons) of the aft mounting assembly are connected, they are locked in place by the spring-loaded lock pin.

The basket is now fully secured. However as an additional safety precaution, the operator returns to the forward end of the basket to engage the lower forward mount. The operator simply ensures the hole in the y-shaped yoke is aligned with the opening in the basket and inserts a standard aviation pip-pin to lock it in place. This feature is merely an additional level of redundancy in the event of a failure of one of the spring-loaded locking pins. It is also contemplated that all connections could feature manually inserted locking pins or the like.

To remove the basket, the operator performs the process in reverse. The forward lower mount is disengaged. The operator moves to the aft end of the basket. The spring loaded locking pin on the upper aft mount is then released and the aft end of the basket lifted upwards to disengage the upper and lower connectors. The (now free) aft end of the basket can be pivoted away from the helicopter (if necessary to avoid contact with it) and lowered to the ground. The operator then returns to the forward end of the basket and releases the spring-loaded locking pin from the upper forward mount. He or she lifts the forward end of the basket, thus disengaging the eyebolt/gimbal mount from the aircraft and lowering the forward end of the basket to the ground.

It will be appreciated by those skilled in the art that the preferred and alternative embodiments have been described in some detail but that certain modifications may be practiced without departing from the principles of the invention.

What is claimed is:

1. A mounting assembly for mounting a cargo basket on a helicopter comprising a plurality of connectors, at least one of said plurality of connectors being an articulating connector.

2. The mounting assembly of claim 1 wherein at least one of said plurality of connectors being a y-shaped connector for connecting to a portion of said cargo basket.

3. The mounting assembly of claim 1 wherein said articulating connector comprising a gimbal assembly.

4. The mounting assembly of claim 3 wherein said gimbal assembly comprises a gimbal pin mounted within a gimbal retainer block.

5. The mounting assembly of claim 4 wherein said gimbal pin has a gimbal pin shank terminating in shoulder, said shoulder having a diameter larger than the diameter of said gimbal pin shank.

6. The mounting assembly of claim 1 further comprising:
a first mounting assembly comprising a first mounting element fixedly connected to a landing gear crosstube of said helicopter, said first mounting element having an upper mount and a lower mount, and said articulating connector and a secondary connector on said cargo basket;
a second mounting assembly comprising a second mounting element fixedly connected to a landing gear crosstube of said helicopter, said second mounting element having an upper mounting connector and a lower mounting connector, and an upper connector and a lower connector connected to said cargo basket.

7. The mounting assembly of claim 6 wherein said articulating connecting being adapted to connect to said upper mount, said secondary connector adapted to be connected to said secondary connector, said upper connector being adapted to connect to said upper mounting connector and said lower connector adapted to connect to said lower mounting connector thereby securing said cargo basket to said helicopter.

8. A method of mounting a cargo basket on a helicopter using the mounting assembly of claim 6 comprising:
aligning said cargo basket with said first and second mounting elements connected to said helicopter;
lifting a portion of said cargo basket and aligning said articulating connector with said upper mount and connecting thereto;
lifting and rotating said cargo basket to align said upper connector and said lower connector with said upper mounting connector and said lower mounting connector respectively and connecting them thereto; and
securing said lower mount to said secondary connector.
